(19) United States
(12) Patent Application Publication
(10) Pub. No.: US 2020/0122166 A1
(43) Pub. Date: Apr. 23, 2020

(54) MULTI-MODE FILTERED SHOWERHEAD CONVERTIBLE INTO DIFFERENT CONFIGURATIONS

(71) Applicant: David K. Farley, Corona, CA (US)

(72) Inventor: David K. Farley, Corona, CA (US)

(21) Appl. No.: 16/163,369

(22) Filed: Oct. 17, 2018

(51) Int. Cl. B05B 1/18; E03C 1/04; B05B 1/16

(52) U.S. Cl. CPC B05B 1/18; B05B 1/16; E03C 1/0409

(57) ABSTRACT

A multi-mode showerhead having a housing with a front and a back and an offset integrated water filter system incorporated into the showerhead. The multi-mode showerhead may be provided with a plurality of water outlets having shower nozzles therein, including a handheld unit that is magnetically or mechanically held at one end of the housing. A selector switch and other water flow control devises are used to selectively control the flow of water through the showerhead. The entire showerhead with the first and second spray nozzle assemblies and the integrated offset water filter system is mounted on a shower arm by means of a single water inlet on the back of the housing and connected to a hollow filter chamber having a water filter cartridge held therein.

### BACKGROUND OF THE INVENTION

### 1. Field of the Invention

This invention generally relates to multi-mode filtered showerheads and, more particularly, to a multi-mode filtered showerhead which is convertible into different configurations.

### 2. Description of the Prior Art

Shower filters for use in conjunction with showerheads and multi-mode filtered showerheads for use in showers are known. One such multi-mode filtered showerhead assembly is set forth in U.S. Pat. No. 9,504,940 to Farley (“940”). This prior art device discloses a multi-mode showerhead that has a housing with a front and a back and an offset integrated water filter system incorporated into the housing. This prior art showerhead may be easily mounted to a normal shower arm without the need of special tools and a water filter cartridge is easily added to or removed from a hollow filter chamber formed in the showerhead housing by the removal of a front facing filter chamber cap. Furthermore, a single nozzle assembly is integrally formed in the front of the housing at the end away from the hollow filter chamber and a switch to selectively change the spray pattern from the nozzle assembly is mounted on the front, between the water filter system and the nozzle assembly. The entire showerhead and integrated offset water filter system is mounted on a shower arm by means of a swivel joint forming an inlet on the back of the housing and fluidly connected to the hollow filter chamber to provide improved filtration of water passing through the showerhead.

A further multi-mode filtered showerhead assembly is set forth in pending U.S. patent application Ser. No. 15/848,565, filed on Dec. 20, 2017, to Farley (“'565”). This prior art device discloses a multi-mode showerhead similar to that in the '940 patent, but further includes at least a second, removable shower nozzle assembly. This removable nozzle assembly replaces the front facing filter chamber cap so as to provide a multi-mode filtered showerhead with multiple nozzle assemblies that may be selectively controlled to provide filtered water through either or both of the nozzle assemblies, as desired by a user. A water filter cartridge is still easily inserted into and removed from the hollow filter chamber in the showerhead by removing the second, removable shower nozzle assembly from a front opening in the water filter housing.

There still exists a need in the art for an easy-to-install and move, unique modern showerhead and water filter system that may be easily converted into different configurations with a plurality of shower nozzle assemblies, including a fixed nozzle assembly, a handheld unit and, if desired a removable shower nozzle assembly. The water flow in the showerhead to the nozzle assemblies is selectively controlled to provide a diverse flow of filtered water. Such a showerhead may be configured to allow a water filter cartridge to be added to or removed from a water filter housing at one end, from either the front or rear of the showerhead.

### SUMMARY OF THE INVENTION

The filtered showerhead of the present invention provides many advantages including, but not limited to the following:

1) Minimizes showerhead extension by use of an offset shower water filter system placed at one end of a showerhead having multiple nozzle assemblies, one of which is a handheld unit that is releasably or removably held to one end of the showerhead, either magnetically or mechanically.

2) Front and/or rear loading of a replacement filter cartridge in the showerhead by removal of a rear portion of the showerhead or a front facing removable shower nozzle assembly, a magnetic holding assembly, or a mechanical holding assembly.

3) A handheld shower wand releasably or removably held to a removable shower nozzle assembly, a magnetic holding assembly or a mechanical holding assembly, so as to provide a user with the option of selectively using one or more of a plurality of shower nozzle assemblies.

4) The filtered showerhead of the present invention provides multiple nozzle assemblies with easy adjustment of the spray patterns from these nozzle assemblies, thereby allowing a unique and optimum water flow pattern directed to the user, so as to provide a more enjoyable shower experience.

5) Positioning of a handheld nozzle assembly in the front or water side of the showerhead and releasably or removably holding this handheld unit in place on a front facing removable shower nozzle assembly, a magnetic holding assembly or a mechanical holding assembly which also are water filter chamber caps, allows for a wider distribution of spray nozzles in the showerhead. Such configurations allow for a more diverse water flow and more enjoyment during a shower.

Accordingly, it is a general object of the present invention to provide an improved combination showerhead and filter assembly. It is a more particular object of the present invention to provide a combination showerhead and offset water filter system. It is a further object of the present invention to provide a combination showerhead and filter assembly with multiple nozzle assemblies. It is yet another object of the present invention to provide an offset filtered showerhead with multiple nozzle assemblies, one of which is a handheld unit that may be easily released from or secured to the showerhead. It is a still further object of the present invention to provide a novel offset filtered showerhead that has an integrated design which is more aesthetically pleasing, provides a more diverse and enjoyable shower experience and allows access to a filter cartridge by either the removal of the showerhead, or a front facing removable water filter chamber cap in the form of a shower nozzle assembly, or containing a magnetic or mechanical holding.

In accordance with one aspect of the present invention there is provided, a combination multi-mode showerhead having multiple nozzle assemblies, one of which is a handheld unit and an offset integrated water filter system incorporated into the showerhead and which showerhead may be easily mounted to a shower arm without the need of special tools.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, wherein:

FIG. 1 is a partial, exploded front perspective view of a first embodiment of a combination multi-mode showerhead having multiple nozzle assemblies and an offset integrated water filter system of the present invention; one of the nozzle assemblies is a handheld unit that may be releasably or removably connected to a mechanical holding assembly mounted on the showerhead;

FIG. 2 is a side elevational view of the showerhead of FIG. 1, mounted on a shower arm with the wand of the handheld unit shown released or separated from the mechanical holding assembly on the showerhead;

FIG. 3 is a side elevational view of the showerhead of FIG. 1 mounted on a shower arm with the wand of the handheld unit shown mechanically attached to the showerhead;

FIG. 4 is a partial, exploded front perspective view of a second embodiment of a combination multi-mode showerhead having multiple nozzle assemblies and an offset integrated water filter system of the present invention showing the wand of the handheld unit having a magnetic coupling means that may be releasably or removably connected to a magnetic holding assembly mounted on or in a filter chamber cap or nozzle;

FIG. 5 is a side elevational view of the showerhead of FIG. 4 mounted on a shower arm with the wand of the handheld unit shown released or separated from the magnetic holding assembly of the showerhead;

FIG. 6 is a side elevational view of the showerhead of FIG. 4, mounted on a shower arm with the wand of the handheld unit shown magnetically attached to the showerhead;

FIGS. 7 and 8 show side elevational views of the showerhead of present invention, mounted on a shower arm, with dotted line depictions of the direction of various flows of water from the shower arm through the water filter and then out the various nozzle assemblies, depending on the configuration of the nozzle assemblies on the showerhead and the adjustment and arrangement of the water flow control devices held in the showerhead and/or the nozzle assemblies.

### DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide for a combination multi-mode showerhead having an offset integrated water filter assembly and multiple shower nozzle assemblies.

The combination multimode showerhead having multiple nozzle assemblies (or spray-heads) and an offset integrated water filter system of the present invention is mounted directly on a regular shower arm coming out of a shower wall (not shown), and is normally screwed onto or otherwise sealingly secured to the shower arm and extending into the shower area.

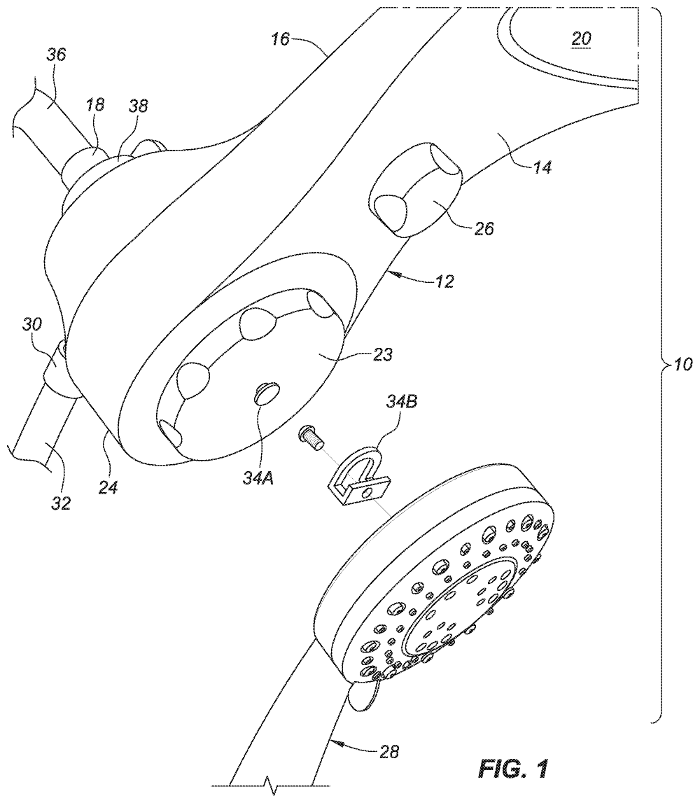

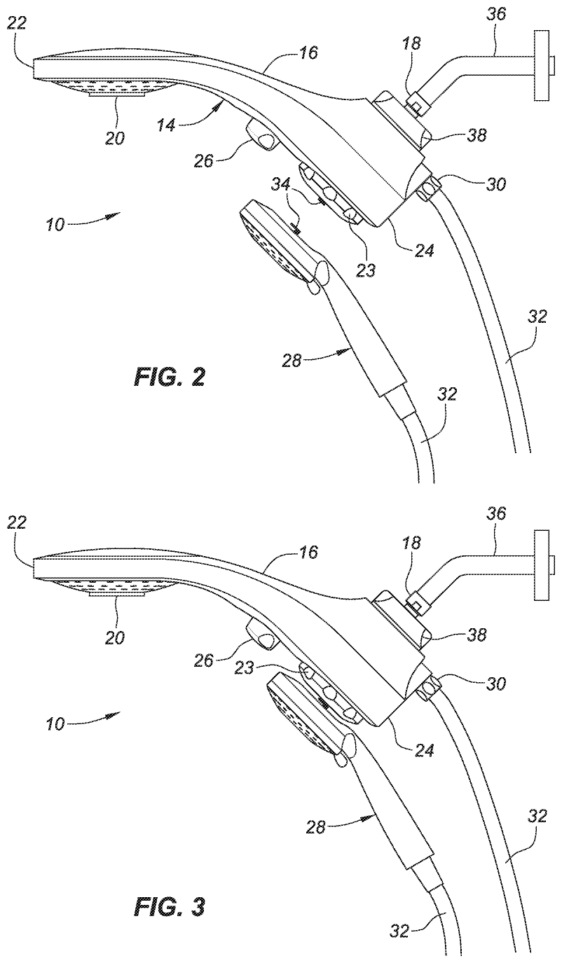

Turning now to the drawings, FIGS. 1-3 illustrate a first embodiment of a multi-mode showerhead 10 having an offset integrated water filter system, as shown and described in the '940 patent and '585 pending application, incorporated in the showerhead. The showerhead 10 includes a multi-piece main body or housing 12 with a front face or portion 14 and a rear surface or portion 16. The body 12 has a single water inlet 18 and a plurality of water outlets or nozzles. The outlets include a first nozzle assembly 20 formed integrally with or held in the front portion 14, as described and shown in the '940 patent and '585 pending application which disclosure is hereby incorporated herein by this reference thereto. This nozzle assembly 20 is at an outer end 22 of the showerhead (best shown in FIGS. 2 and 3).

A second nozzle assembly or water outlet 23 may be held at a second end 24 of the showerhead and may include a magnetic or mechanical holding assembly. Or, in place of this second nozzle assembly or water outlet a magnetic or mechanical holding assembly may be provided on a cap at the second end. A mode selector switch or knob 26 is held in a central portion of the front face 14, between the first nozzle assembly 20 and the second nozzle assembly, the magnetic holding assembly or the mechanical holding assembly (whichever configuration is provided).

In a preferred embodiment of the invention a handheld unit or nozzle assembly 28 is fluidly connected to the second end 24 by means of water outlet 30 attached thereto. The wand of the handheld unit is fluidly attached to the water outlet 30 by means of a hose 32. Various means, such as conduits, deflectors, control valves, or the like, may be selectively provided internally and externally of the showerhead to control and direct water entering the water inlet 18 through a shower filter held in an internal chamber at the second end 24 to the desired nozzle assemblies.

As shown in FIGS. 1-3, the handheld unit or nozzle assembly 28 is mechanically releasably or removably connected to the cap or holding assembly 23 by means of a clip element 34 comprised of two parts, such as holding element 34A secured in the cap 23 and a clip 34B secured to the head of the wand of the handheld unit, as by means of a screw or the like. Other known types of mechanical holding means may also be used, if desired.

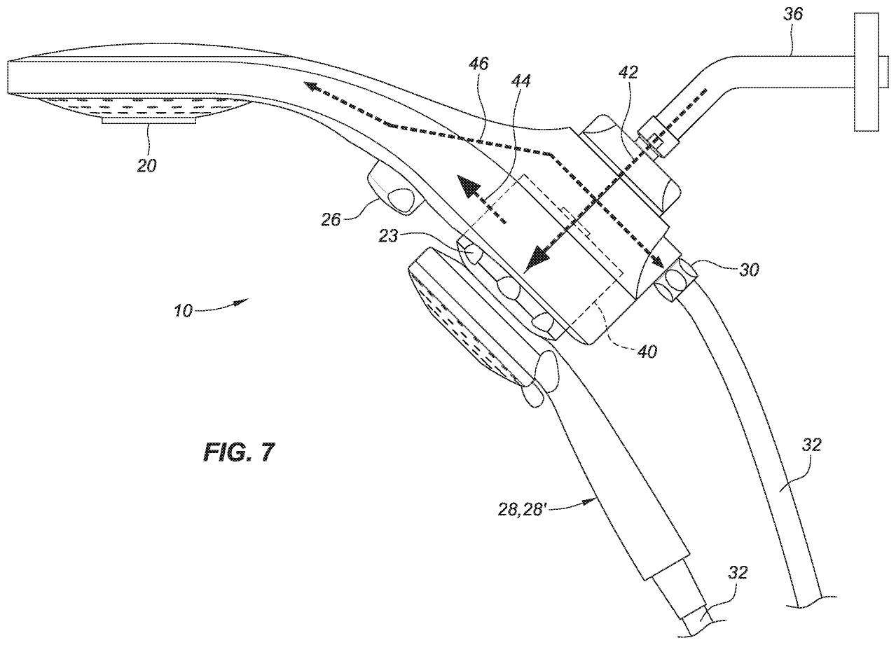

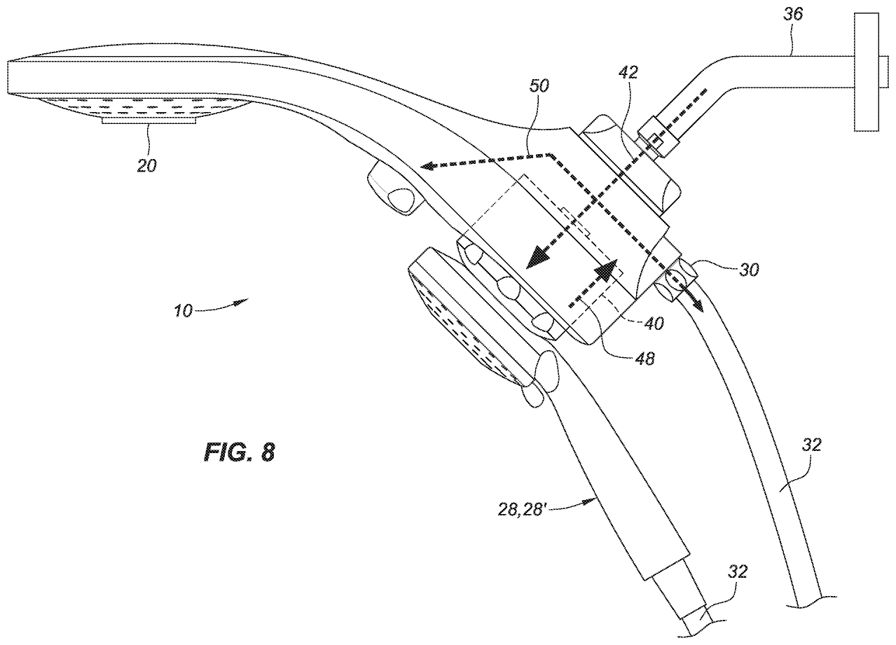

The multi-piece body or housing 12 having the handheld unit 28 connected thereto is easily screwed onto a normal or regular shower arm 36 coming out of a shower wall (not shown) by means of a connector or connecting element forming the water inlet 18 on an enlarged upper area of the rear surface or portion 16 of the housing 14, at the second end 24. This water inlet area may, if desired, be provided with a removable cap or the like 38 to allow a water filter cartridge 40 (shown in FIGS. 7 and 8) to be added or changed before the showerhead is mounted on or if removed from the shower arm.

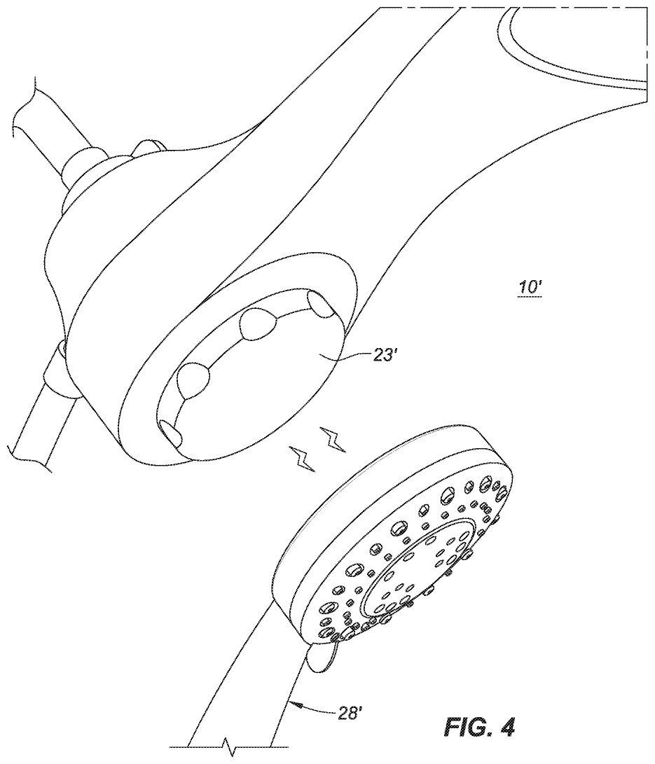

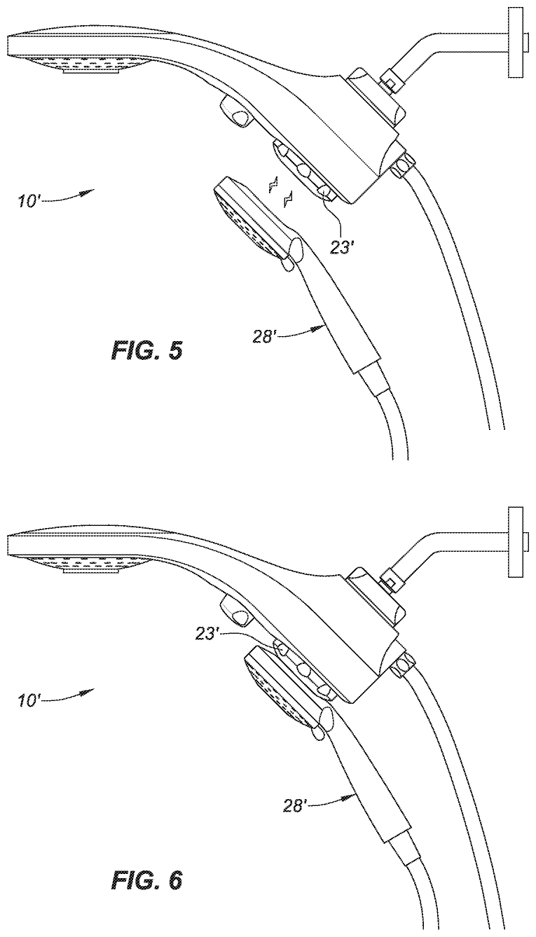

FIGS. 4-6 of the drawings show a second embodiment of the invention wherein a handheld unit or nozzle assembly 28′ is magnetically releasably or removably connected to a cap or holding assembly 23′ on the showerhead 10′ by means of magnets held in the cap 23′ and handheld unit 28′ or by magnetizing selected portions of each. In all other respects, other than how the handheld unit is connected or secured to the cap 23′, and how they are moved apart, this embodiment is identical to the first embodiment, as described above.

As shown in FIGS, 7 and 8, when either embodiment of the showerhead of the present invention is properly mounted on a shower arm, in any known manner, water enters from the shower arm through the inlet and flows through the filter cartridge 40, shown in broken line.

First, if all the water flow control devices, including selector switch 26 are adjusted, water can be made to enter the showerhead from the shower arm and, as shown by arrow 42 in FIG. 7, the water will enter a hollow internal chamber and pass through filter cartridge 40. If a second nozzle assembly or water outlet 23 is mounted at a second end 24 of the showerhead, water may exit from there, if not somehow blocked. Or, if a cap 23, 23′ is mounted on the showerhead, water, after passing through the filter cartridge, will flow in the direction shown by arrow 44 toward the selector switch 26. The selector switch may be adjusted to split the water flow (see arrow 46) so as to flow to and out the first nozzle assembly 20 and through the outlet 30 to the hose 32 and the handheld unit 28, 28′.

FIG. 8 shows a similar water flow (arrow 42) into the hollow internal chamber, however, the water is shown as being deflected and flowing upwardly (see arrow 48) to then flow toward the selector switch 26 and then be split (see arrow 50) so as to flow to the selector switch and the first nozzle assembly 20 and through the outlet 30 to the hose 32 and the handheld unit 28, 28′.

It, therefore, can be seen that the present invention provides an improved, less cumbersome, easy-to-install and use multimode showerhead having multiple nozzle assemblies, including a handheld unit in a housing with an offset integrated water filter assembly providing an integrated design.

Those skilled in the art will appreciate that various adaptations and modifications of the just-described preferred embodiment may be configured without departing from the scope and spirit of the invention. Therefore, it is to be understood that, within the scope of the appended claims, the invention may be practiced other than is specifically described herein.

What is claimed is:

1. A convertible configuration, multi-mode showerhead and integrated offset water filter system, comprising;
a housing having a front portion and a rear portion with a water inlet in the rear portion and a plurality of water outlets in the housing;
an integrated hollow water filter cartridge chamber in the housing at one end of the housing and fluidly connected with the water inlet;
a first nozzle assembly fluidly connected to one of the water outlets at said one end of the housing and fluidly connected to the hollow water filter cartridge chamber; and
a multi-mode selector element held on the front portion and fluidly connected between the hollow water filter cartridge chamber and a second nozzle assembly in one of the water outlets in the front portion at a second end of the housing, for selectively directing water out of the nozzle assemblies.

2. The convertible configuration multi-mode showerhead and water filter assembly of claim 1, further including a removable water filter cartridge held in the hollow water filter cartridge chamber and wherein the first nozzle assembly is a hand held unit removably held on said housing.

3. The convertible configuration multi-mode showerhead and water filter assembly of claim 1, wherein the first nozzle assembly is a hand held unit removably held on said housing.

4. The convertible configuration multi-mode showerhead and water filter assembly of claim 3, further including a removable water filter cartridge held in the water filter cartridge chamber.

5. The convertible configuration multi-mode showerhead and integrated offset water filter system of claim 4 wherein the first nozzle assembly includes mechanical means formed thereon to enable the first nozzle assembly to be removably mounted on the housing.

6. The convertible configuration multi-mode showerhead and integrated offset water filter system of claim 4 wherein the first nozzle assembly includes magnetic means formed thereon to enable the first nozzle assembly to be removably mounted on the housing.

7. A convertible configuration multi-mode showerhead and integrated offset water filter system comprising:
a housing having a front portion and a rear portion with a water inlet in the rear portion and at least two water outlets having spray nozzle assemblies in the front portion;
a first spray nozzle assembly fluidly connected to one of the water outlets at one end of the housing and fluidly connected to the hollow water filter cartridge chamber;
a removable water filter cartridge held in the water filter cartridge chamber and selectively inserted and removed from the water filter cartridge chamber; and
a multi-mode selector element held on the front portion in a central portion and fluidly connected between the integrated hollow water filter cartridge chamber, the first spray nozzle assembly and a second spray nozzle assembly held in a second water outlet in the front portion for selectively directing water exiting the multi-mode selector element out of the first and second spray nozzle assemblies.

8. The convertible configuration multi-mode showerhead and integrated offset water filter system of claim 7 wherein the first nozzle assembly is a hand held unit removably held on said housing.

9. The convertible configuration multi-mode showerhead and integrated offset water filter system of claim 8 wherein the first nozzle assembly and the housing include mechanical means formed thereon to enable the first nozzle assembly to be removably mounted on the housing.

10. The convertible configuration multi-mode showerhead and integrated offset water filter system of claim 8 wherein the first nozzle assembly and the housing include magnetic means formed thereon to enable the first nozzle assembly to be removably mounted on the housing.

11. A convertible configuration multi-mode showerhead and integrated offset water filter system comprising:
a housing having a front portion and a rear portion with a water inlet in the rear portion;
the front portion having a first water outlet with a hand held unit attached thereto;
the hand held to unit being removably mounted on the housing;
a removable water filter cartridge held in a water filter cartridge chamber and selectively inserted and removed from the chamber, which chamber is fluidly connected to the hand held unit;
a multi-mode selector element held on the front portion in a central portion between the first water outlet and a second water outlet and fluidly connected between the integrated hollow water filter cartridge chamber and the hand held unit and a second spray nozzle assembly for selectively directing water exiting the multi-mode selector element out of the hand held unit and the second nozzle assembly.

12. The convertible configuration multi-mode showerhead and water filter assembly of claim 11, wherein the hand held unit is mechanically connected to the housing.

13. The convertible configuration multi-mode showerhead and water filter assembly of claim 11, wherein the hand held unit is magnetically connected to the housing.
